(19) United States
(12) Patent Application Publication
(10) Pub. No.: US 2015/0060074 A1
(43) Pub. Date: Mar. 5, 2015

(54) Methods and Fluid Compositions for Creating a Wellbore

(71) Applicants: Ramesh Varadaraj, Bartlesville, OK (US); Copper E. Haith, Bethlehem, PA (US); Barbara Carstensen, Annandale, NJ (US); Cornelius H. Brons, Easton, PA (US)

(72) Inventors: Ramesh Varadaraj, Bartlesville, OK (US); Copper E. Haith, Bethlehem, PA (US); Barbara Carstensen, Annandale, NJ (US); Cornelius H. Brons, Easton, PA (US)

(21) Appl. No.: 14/330,959

(22) Filed: Jul. 14, 2014

Related U.S. Application Data
(60) Provisional application No. 61/870,656, filed on Aug. 27, 2013.

(51) Int. Cl. C09K 8/04; C09K 8/584; E21B 43/16

(52) U.S. Cl. CPC C09K 8/04; E21B 43/16; C09K 8/584
USPC 166/305.1; 507/259; 507/135

(57) ABSTRACT

An operations fluid composition for operations on wells associated with the production of hydrocarbons, the fluid composition comprising: not less than 40 wt % of hydrocarbon fluid, based upon the total weight of the fluid composition; water; and from 0.1 to 10 wt % of a surfactant selected from alkyl acid surfactant, based upon the total weight of water in the fluid composition. Method for using the same are also disclosed.

### CROSS REFERENCE TO RELATED APPLICATIONS

This application claims the benefit of U.S. Provisional No. 61/870,656, filed Aug. 27, 2013, the entirety of which is incorporated herein by reference for all purposes.

### FIELD

The present disclosure relates generally to non-aqueous fluid compositions that may be suitable for wellbore drilling, completion, and/or stimulation of earthen formations such as carbonate and/or sandstone reservoir formations. More particularly, the present disclosure relates to fluids and methods for enhancing acid stimulation of oil and/or gas bearing carbonate and sand stone subterranean formations through use of the presently disclosed fluid compositions and methods in drilling, completing, and/or stimulating the well.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

For the purposes of the present application, it will be understood that hydrocarbons refers to an organic compound that includes primarily, if not exclusively, the elements hydrogen and carbon. Examples of hydrocarbon-containing materials include any form of natural gas, oil, coal, and bitumen that can be used as a fuel or upgraded into a fuel. Hydrocarbons are commonly found in subsurface formations. As used herein, the term formation refers to a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state. A formation can refer to a single set of related geologic strata of a specific rock type, or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

Operators of hydrocarbon-related wells are engaged in a variety of activities designed to extract hydrocarbons or hydrocarbon-containing materials from a formation. A variety of wells and well types can be drilled into and a variety of operations can be conducted on a single formation in an effort to extract those hydrocarbons. The strategy for the wells and the operations depends on the formation's stage of development, the nature of the formation, and the nature of the hydrocarbon-containing materials in the reservoir associated with the formation, etc. For example, drilling operations are typically required to create the wellbores necessary to reach and exploit hydrocarbon production from the earthen formation. Drilling operations typically utilize a drilling fluid or “mud” during the drilling process, a portion of which tends to build a filter cake or mud cake on the wellbore face. Commonly, wellbores are drilled with a non-aqueous fluid to minimize formation damage. However, the formation in proximity of the wellbore may nonetheless experience plugging and damage from absorption of the drilling fluid and/or materials within the drilling fluid.

Additionally, the wells may be equipped and completed, such as by positioning tubular casing and/or one or more pieces of downhole related equipment in the borehole (i.e., the space evacuated by the drilling operation within the wellbore, which includes the formation face). A completion process may include wellbore damage remediation and/or formation stimulation to mitigate the formation damage that may have occurred during drilling and naturally occurring formation production obstacles. After completion the well may be put on production, injection, disposal, storage, or related use-related operations. Stimulation fluids may be introduced into the borehole and/or near-wellbore formation to remediate damage and/or fluidly connect the well bore to the reservoir by forming wormholes, fractures, effective permeability pathways, etc., for the flow of formation fluids.

The art is ripe with fluids, methods, and systems for drilling, completing, and/or stimulating formations and/or remediating formation drilling damage, using acids to dissolve reactive formation media, thereby creating pathways of improved impermeability. Acidizing techniques such as acid washes, matrix stimulation jobs, foamed acid stimulations, acid fracturing, propped fracturing using acids, etc., are all well known in the art, using a range of inorganic and organic acids. Common acids include acetic, citric, hydrochloric, hydrofluoric, formic, nitric, sulfuric, chloroacetic, and sulfuric. For example, HCl acid may be delivered into the formation in concentrations such as from 2 wt % to 35 wt %, commonly 15%. Targeted formations commonly include carbonate based formations, but sandstone formations and drilling fluid residue may also benefit from acid treatments.

There are multiple factors that may limit an operator's ability to stimulate a carbonate or a sand stone reservoir. One common factor is the presence of filter cake accumulated on the wellbore and/or downhole equipment in the borehole due to previous fluids in the wellbore, such as during drilling the wellbore. Filter cake as used herein may refer to the residue deposited on a medium, such as the wellbore face during drilling. The filter cake is frequently created when a permeable medium, when a slurry, such as drilling fluid (“mud”) is forced against the medium under a pressure. Filter cake properties, such as cake thickness, toughness, slickness, and permeability are important because the cake that forms on permeable regions of the wellbore can be beneficial to an operation or may be detrimental to an operation. Some problems that a filter cake may present include formation damage and corresponding reduced permeability affecting production and/or stimulation operations. While filter cakes can present numerous challenges or disadvantages, operators also know that there are various advantages provided by filter cakes, such as limiting the loss of drilling fluid to the formation, reducing risks of contaminating or damaging a reservoir during drilling, retaining formation fluids during drilling to prevent kicks, etc. Accordingly, there has been a long history of publications and inventions directed to targeted creation and removal or remediation of filter cakes.

Filter cakes may be formed from aqueous and non-aqueous slurries. The properties of the filter cakes and the available remediation methods may vary depending on the type of slurry used when the filter cake forms. For example, it is well known that filter cakes formed from a non-aqueous fluid (NAF), such as an oil-based or synthetic oil-based drilling mud, exhibit far less permeability than a filter cake formed from an aqueous fluid and are also more difficult to remediate. While the decreased permeability of NAF filter cakes may suggest using aqueous drilling fluids to avoid the NAF filter cake, some implementations require NAF drilling fluids for a variety of reasons, as is well known. The decreased permeability of a NAF filter cake, or filter cake formed from NAF slurries, has been observed to complicate the remediation of the filter cake, often necessitating complex treatment fluids. In some proposed solutions, the NAF filter cake is only treatable by using a coordinated system of drilling muds and treating fluids.

Exemplary teachings known in the art include the use of chelating agents to extract metallic weighting agents from filter cakes, the use of acidic treatment fluids to dissolve the filter cake elements, and/or the use of surfactants to clean the filter cake from the surface of the wellbore. One exemplary publication of such teaching may be found in U.S. Patent Publication No. 2008/0110621. Other exemplary related publications may be found in U.S. Patent Publication Nos. 2007/0029085 and 2008/0110618; and in U.S. Pat. Nos. 5,909,774; 6,631,764; 7,134,496; and in Single-phase Microemulsion Technology for Cleaning Oil or Synthetic-Based Mud; Lirio Quintero, et al; 2007 AADE National Technical Conference, Apr. 10-12, 2007.

U.S. Pat. No. 5,909,774A discloses fluid for enhanced acidization. The types of surfactants disclosed are: a) Non-ionic surfactants which are alkly ethoxylated alcohols b) sodium alkyl aryl sulfonates c) sodium alkly sulfates d) sodium dioctyl sulfosuccinate e) sodium alpha olefin sulfonate. The sulfonates are salts of alkali metals such as sodium or potassium.

U.S. Pat. No. 6,631,764B2 discloses use of Suitable pH modifying agents include mineral acids (such as hydrochloric acid), organic acids (such as formic acid, acetic acid, or citric acid), and chelating agents, in particular cationic salts of polyaminocarboxylic acids chelating agents suitable typically using at neutral or mild pH, ranging from 3.5 to 8.0.

US20070029085A1 discloses wettability modifiers include partially or completely fluorinated surfactants or polymers, for example fluorosilanes such as perfluorosilanes, urethane oligomers containing perfluoro alkyl moieties, fluoroacrylates, and fluoroalkyl containing terpolymers or their mixtures. Other examples include surfactants, for example viscoelastic surfactants such as cationic surfactants such as quaternary amines, and zwitterionic surfactants, such as betaines.

U.S. Pat. No. 7,134,496B2 discloses a microemulsion fluid for remediating a filter cake. The microemulsion fluid contains water, oil and surfactants. It is disclosed that surfactants suitable for creating the single phase microemulsions include nonionic, anionic, cationic and amphoteric surfactants and in particular, blends thereof. Co-solvents or co-surfactants such as alcohols are optional additives used in the microemulsion formulation. Suitable nonionic surfactants include alkyl polyglycosides, sorbitan esters, methyl glucoside esters, or alcohol ethoxylates.

Other proposed solutions have attempted to use chelating agents to remove metallic weighting agents from the filter cake, such as US20080110621A1. While these solutions provide some improvement or some level of remediation, the conventional approaches are costly and complex.

It has been determined that a frequent potential cause for ineffective acid stimulation after drilling with a NAF mud is the creation of a “water-in-filter cake” material that forms when an aqueous-based acid, for example HCl mixed with water, permeates the NAF filter cake on the wellbore wall. This “water-in-filter cake” material creates a viscoelastic barrier for the acid to penetrate the cake and react with the carbonate or sand stone surface. The NAF that creates such a filter cake can be termed “damaging” in the context of acid stimulation. Accordingly, need exists for improved systems and methods for breaking or remediating NAF wellbore filter cake, particularly for the purpose of stimulation of hydrocarbon bearing reservoirs and injection or disposal wells.

### SUMMARY

The present disclosure overcomes the limitations of the known art by providing compositions, methods, and systems for minimizing or reducing formation and/or wellbore damage caused by NAF mud filter cake. Provided herein is a drilling mud or wellbore operation fluid that creates a NAF filter cake that is less damaging with respect to acid stimulation success than many prior art NAF filter cakes and may be easier to remediate than other NAF filter cakes. Compositions, methods, and systems for efficiently remediating or avoiding permeability and other NAF drilling mud issues created by an NAF mud and/or filter cake are provided.

The disclosure includes fluid compositions, methods, and systems that may be useful as a drilling fluid, stimulation fluid, and/or completion fluid. Other applications may include use as or with an acid stimulation system. For brevity, the various fluid compositions disclosed herein may be collectively and/or individually referred to herein as an “operations” fluid, whereby the operations that may use such compositions, methods, and/or systems may include one or more of a drilling operation, a completion operation, a workover operation, a stimulation operation, or another wellbore-construction or wellbore-use related operation.

One beneficial effect is that NAF filter cakes created by the disclosed NAF mud compositions may more readily “break” and/or disassociate the solid particulates within the filter cake as compared to many prior fluid systems, resulting in less formation damage and more effective subsequent acid penetration and formation stimulation. The earthen formation at or around the wellbore face may be more effectively treated or etched to create desirable worm-holing during a subsequent acid stimulation job than may occur without first breaking down the NAF filter cake.

A related use for the composition provided herein is as a wellbore drilling or operations fluid, or in conjunction with an NAF wellbore drilling fluid, whereby the NAF filter cake formed by using such fluid may create favorably altered filter cake wettability and solid-particulate dispersion properties that are more amenable to filter cake removal and formation damage mitigation as compared to NAF filter cakes resulting from prior drilling fluid systems.

The disclosed operations fluid includes a hydrocarbon base fluid (NAF) and an alkyl-acid-containing surfactant. The alkyl acid surfactant component may include an aryl alkyl or an alkyl-aryl containing acid, but for brevity, are referred to herein collectively merely as an alkyl acid. Alkyl acid containing surfactants have demonstrated effective potential to enhance NAF filter cake properties and or to enhance the effectiveness of a subsequent acid stimulation of an earthen formation behind an NAF filter cake has been surprisingly impressive.

The alkyl acid surfactants of the instant invention are also compatible with primary stimulation acids used in a stimulation of carbonate reservoirs such as inorganic acids, such as hydrochloric acid, hydrofluoric acid, nitric acid, and sulfuric acid. The subject alkyl acids are compatible with the corrosion inhibitors and many other additives used with such acid stimulation systems. The compatibility is advantageous as it permits use of the alkyl acid surfactant not only as the drilling fluid as explained herein, but additionally permitting use of the surfactant within a “stage” or step of the acid stimulation job, such as within the pad or first stage of the treatment job. Often, the appropriate additional stage may be as a pre-treatment or as an initial stage, or in conjunction a formation-damage-removal stage of an acid stimulation job that includes the primary stimulation acid. Even if not used in the acid stimulation treatment, the NAF filter cake created by the subject drilling fluid compositions is compatible with and generally readily amenable to subsequent acid stimulation treatments.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments described below. But rather, the invention includes all alternatives, modifications, and equivalents falling within the scope of the appended claims.

The present disclosure is directed to operations fluids and uses for the same, in operations useful for use in preparing or drilling wellbores such as may be associated with hydrocarbon recovery operations. Exemplary applications of the subject operations fluid may include uses as a NAF drilling fluid for drilling or creating a wellbore, remediation of NAF filter cakes created by other NAF fluid systems, creating less-damaging filter cakes as compared to other NAF filter systems. The operations fluid may also be useful as a drilling fluid or remedial clean-up fluid, to facilitate an improved acid stimulation of hydrocarbon bearing formations behind such filter cakes, such as oil and/or gas bearing carbonate and/or sandstone reservoir formations, and including methods and systems for using such operations fluids. Exemplary fluids may be generally referred to herein as “operations fluid” and may comprise primary components such as a hydrocarbon NAF component and at least one alkyl-acid-containing surfactant. Water may optionally be present in the subject fluid systems. Typically, the operations fluids described herein are associated with drilling and/or completing a wellbore, such as a drilling mud or completions fluid.

The described operations fluid may be more commonly useful as a NAF drilling fluid. A drilling fluid embodiment of the operations fluid may include for example, a hydrocarbon base fluid (NAF), such as oil or other non-aqueous fluid as may be used in creating a synthetic or oil-based drilling mud, and further includes the alkyl-acid-containing surfactant. In some exemplary embodiments, the drilling or completions fluid may include, for example, not less than 40 wt % hydrocarbon content (such hydrocarbon fluids as may be utilized in an oil-based drilling mud) based upon the total fluid weight of the drilling fluid composition. In other exemplary embodiments, the fluid may include from 40 wt % to 70 wt % hydrocarbon content, 50 wt % to 70 wt % of hydrocarbon fluid, based upon the total weight of the drilling fluid composition. In some aspects, the drilling fluid may include from 2 to 20 wt %, or 2 to 10 wt %, of alkyl-acid-containing surfactant, based upon the total fluid weight of the composition.

The fluid may also include water or an aqueous component, such as 5 to 20 wt % water or aqueous component in addition to the nonaqueous fluid component, although such aqueous component is typically in lesser amount lower than the amount of hydrocarbon or non-aqueous fluid present. Typically, an aqueous component, such as water, may be less than 25 wt %, based upon the total weight of all liquid and solids components within the operations fluid system. The aqueous component may also be present in the system, such as, for example, from 5 to 20 wt % of water, while the hydrocarbon component may comprise 20 to 75 wt % of the total liquid, based upon the total weight of the drilling mud composition. The operations fluid may include from 2 to 50 wt % of solid particulate media, or 5 to 50 wt %, or 10 to 50 wt %, or 20 to 50 wt % of added solid particulate media, based upon the total weight of the fluid composition. Exemplary added solids may include barium sulfate, calcium oxide, calcium hydroxide, calcium chloride, clay, barite, residual formation cuttings, and combinations thereof. Other drilling fluid additives may also be present, such as added solids, weighting agents, gelling agents, leak-off control agents, viscosifiers, pH adjusters, salt, drilled cuttings, other solids such as lost circulation materials, barite, clays, flocculants, lost circulation material, emulsifiers, other surfactants, residual drilled solids or formation cuttings not removed from previous circulation, and other additives as may be compatible with creating a NAF drilling fluid of the desired set of rheological properties.

One exemplary method of utilizing the operations fluid may be according to a method of drilling a wellbore while using the subject composition as a drilling fluid. In many applications, the subject fluid composition may be utilized to drill a wellbore into a formation that is to be at least partially subjected to an acid stimulation treatment. The drilling fluid composition may be suitable for use in drilling any of various earthen formations prior to acid stimulation in such formations. An exemplary application may include steps such as but not limited to, drilling a wellbore into an earthen formation, such as a hydrocarbon bearing reservoir formation, using a the subject NAF operations fluid as a drilling fluid (mud). Such NAF fluid may include, for example, an oil-based primary phase (or continuous phase in an emulsion) or other hydrocarbon-containing mud that includes a hydrocarbon base fluid and an alkyl acid containing surfactant.

The hydrocarbon oil or NAF base component of the drilling or operations fluid may include for example, substantially any oil or hydrocarbon-based material, such as but not limited to produced oil or crude, diesel, or a synthetic NAF composition. It may be preferred at times that the NAF hydrocarbon component is a generally non-aromatic oil. In some embodiments, the non-aromatic hydrocarbon oil is a linear or branched hydrocarbon with at least 10 carbon atoms, such as between 10 to 16 carbons atoms. However, 8 to 24 hydrocarbon molecule chains may also be applied according to the present embodiments. The alkyl-acid-containing surfactant component of the operations fluid has the general formula R—X wherein R is selected from the group comprising linear and branched alkyl and aryl alkyl hydrocarbon chains of 8 to 24 carbons. X may be an acid selected from the group comprising sulfonic acids, carboxylic acids, phosphoric acids, and mixtures thereof.

Also provided is a method to stimulate a reservoir formation comprising drilling into a reservoir formation with a non-aqueous fluid drilling mud according to the present teaching. The method may include creating a wellbore using a NAF and then contacting the created NAF filter cake with the subject fluid composition. Contacting the NAF filter cake may include either by using the subject fluid composition as a drilling fluid while drilling or creating the wellbore, and/or contacting the NAF filter cake with the subject fluid composition prior to or substantially contemporaneously while acidizing the reservoir formation. The disclosed methods for using the subject fluid compositions may also include pumping a volume of the operations fluid into the wellbore after drilling the wellbore but prior to the acid treatment, whereby at least a portion of the operations fluid is in contact with the NAF filter cake that is adjacent the reservoir portion of the penetrated formation, such as a conditioning fluid prior to the acid stimulation.

The operations fluid also may be adapted to perform as a treatment fluid for example, to drill a selected section of the wellbore that may benefit from treatment by or use of the presently disclosed non-damaging NAF filter cake building drilling fluid. An exemplary selected section may be a trouble-zone requiring specialized drilling fluid, or a high-value zone, such as the hydrocarbon-bearing reservoir sections of the wellbore. Other exemplary section may be an anticipated high-fluid-loss-zone where loss-controlling filter cake is needed to control loss of the NAF. The present operations fluid may also be utilized as a primary drilling fluid or as a component of a primary drilling fluid system used to drill substantially all or a majority of the wellbore. Other uses or formulation may be adapted for completion fluids or specialized operations fluids, such as but not limited to use as a borehole face-wash, an operations pre-treatment fluid, damage remediation, and/or in stimulation operations.

In some implementations, the operations fluid may be adapted as a remedial operations fluid to remediate a filter cake, such as a NAF filter cake that was created previous to introducing the subject operations fluid into the wellbore. For example, the operations fluid may be adapted to remediate a NAF filter cake by performing at least one of: 1) altering the wettability of a NAF filter cake from oil-wetting to water-wetting; and 2) extracting non-aqueous fluid associated with the NAF filter cake.

The hydrocarbon oil or NAF base component of the drilling or operations fluid may include for example, substantially any oil or hydrocarbon-based material, such as but not limited to produced oil or crude, diesel, or a synthetic NAF composition. It may be preferred at times that the NAF hydrocarbon component is a generally non-aromatic oil. In some embodiments, the non-aromatic hydrocarbon oil is a linear or branched hydrocarbon with at least 10 carbon atoms, such as between 10 to 16 carbons atoms. However, 8 to 24 hydrocarbon molecule chains may also be applied according to the present embodiments.

The fluid composition also includes an alkyl-acid containing surfactant. The alkyl-acid containing surfactant component of the operations fluid has the general formula R—X wherein R is selected from the group comprising linear and branched alkyl and aryl alkyl hydrocarbon chains of 6 to 24 carbons, more commonly 8 to 24 carbons. X may be an acid selected from the group comprising sulfonic acids, carboxylic acids, phosphoric acids, and mixtures thereof. The alkyl acid group R—X may comprise for example, an alkyl acid selected from the group consisting of or including alkyl carboxylic acid, alkyl sulfonic acid, alkyl phosphoric acid, alkyl aromatic carboxylic acid, alkyl aromatic sulfonic acid, alkyl aromatic phosphoric acid, alkyl aryl carboxylic acid, alkyl aryl sulfonic acid, alkyl aryl phosphoric acid and mixtures thereof. The acid group is commonly attached to the alkyl group in the case of alkyl acid and attached to the aryl group in the case of alkyl aryl acid. For example, in dodecyl sulfonic acid the acid group is attached to the dodecyl alkyl group. Also for example, in dodecyl benzene sulfonic acid the acid group is attached to the benzene group.

R is an alkyl or alkyl aryl hydrocarbon chain. In some aspects, the aryl group of the alkyl aryl hydrocarbon is a 1-ring or 2-ring aromatic group. Non-limiting examples of 1-ring aromatic groups are benzene, toluene, and xylene. Non-limiting examples of an alkyl aromatic hydrocarbon chain are dodecyl benzene, decyl xylene, and decyl benzene, decyl toluene and mixtures thereof. In some embodiments, X may be a sulfonic acid group. Non-limiting examples of 2-ring aromatic groups are similarly common 2-ring aromatic groups.

The at least one surfactant may include a single alkyl acid containing surfactant or a mixture of various alkyl acid containing surfactants. The surfactant components are preferably dissolved or dispersed in water. The total surfactant concentration may be in a range of from 0.1 wt % up to 20.0 wt %, based on the weight of water in the operations fluid. Typically, the total concentration of surfactant may be greater than about 0.1 wt % and less than about 10 wt %, and more preferably the total surfactant concentration may be greater than about 0.1 wt % and less than about 2 wt %.

The operations fluid including the alkyl acid surfactants may further comprise dissolved salts, such as but not limited to chloride and sulfate salts of calcium, magnesium, and potassium. The amount of dissolved salts, when included, may be in a range of from 0.01 wt % to 25 wt %, based on the weight of the water, or within a range of from 0.01 wt % to 5 wt %. The operations fluid may further comprise alcohols such as methanol, ethanol, propanol, butanol, pentanol, hexanol, heptanol, octanol and mixtures thereof. The alcohols, when included, may be included in a range of from 0.001 wt % to 15 wt %, based on the weight of water.

Other operations fluid components may also be present within the operations fluid system, such other components being referred to herein generally as secondary components. The secondary components may comprise substantially any compatible and useful additive, such as a variety of system customization components. Exemplary secondary components may include materials such as but not limited to corrosion inhibitors, inhibitor intensifiers, sequestering agents, wetting agents, gelling agents, foaming agents, emulsifiers, demulsifiers, stabilizers, mineral converting agents, proppants, salts, complexers, buffers, pH adjusters, solvents, alcohols, friction reducers, nitrogen, carbon dioxide, and/or combinations thereof. The system may also include crosslinkers, gelling agents, or thickening agents such as polymers, and/or diverting or blocking agents, such as rock salt or benzoic acid flakes, clay stabilizers and/or salts, such as potassium chloride, sodium chloride, magnesium chloride, and/or combinations thereof.

The subject operations fluid may be used in conjunction with substantially any operations use in constructing or preparing the wellbore, or in conjunction with using the wellbore as part of hydrocarbon production or injection operations. Exemplary operations may require adapting the operations fluid for use subsequent to wellbore exposure to a NAF, such as a treatment pill for use during drilling operations, such as to mitigate drill pipe sticking, or subsequent to drilling the wellbore such as during wellbore cleanup operations, or as part of the completion and/or stimulation operations. The operations fluid may be adapted for use during at least one of drilling operations, logging operations, casing operations, completion operations, cementing operations, stimulation operations, production operations, injection operations, or combinations thereof.

One exemplary method of utilizing the operations fluid is with a system or method of pre-treating or enhancing acid stimulation of a reservoir formation after the well bore has been drilled with a NAF drilling mud. Exemplary implementations may include a method to enhance acid stimulation in a reservoir formation comprising, drilling into through a geologic formation using a fluid that contains a non-aqueous fluid (NAF) to create a well bore; obtaining an operations fluid comprising water, an inorganic primary acid, and at least one acid-containing surfactant; pumping a volume of the operations fluid into the well bore that has the NAF filter cake, wherein the volume of operations fluid is pumped to contact the NAF filter cake. The operation may end there with removal of the filter cake or extended somewhat to also work on filter cake that has entered the damaged or altered zone near the wellbore face. The operation may still further be extended to include stimulating the reservoir formation using the operations fluid, such as with a matrix acid stimulation job and/or with an acid-fracturing operation. In still other instances, an operations fluid process that utilizes the subject operations fluid may be conducted in advance of or in conjunction with yet another stimulation operation, such as a further acid stimulation operation or a propped fracturing operation that may or may not include acid.

Using or pumping the operations fluid may broadly include any of a number of methods or applications to remove NAF filter cake damage, remediate near-wellbore formation alterations due to drilling, or to initiate formation stimulation operations. Other exemplary applications may include use of the operations fluid in operations such as jet washing the wellbore face with the operations fluid, spotting operations fluid across a formation or wellbore section, treating a damaged zone around the wellbore, matrix stimulation, mud removal in advance of a cement or gravel pack job, acid fracturing, and/or in conjunction with proppant fracturing. The operations fluid may be adapted for use to remediate a NAF filter cake by a mechanism that performs at least one of (1) altering the wettability of the NAF filter cake from oil wetting to water wetting, and/or (2) extracting non-aqueous fluid associated with the NAF filter cake.

In addition to the operations fluid disclosed herein, other improved aspects are disclosed providing for systems and methods of using the operations fluid. A treatment system is included that may be useful in operations on wells associated with hydrocarbon production, such as production wells, injection wells, and disposal wells. A wellbore or formation treatment system may comprise preparing an operations fluid, such as the operations fluid described and exemplified above. An exemplary system may include an operations fluid that comprises water, an inorganic primary acid, and an alkyl acid surfactant, and the operation fluid is placed into a wellbore. Placing the fluid into the wellbore may also include putting the operations fluid into contact with a wellbore face, such as in contact with a NAF drilling fluid and/or NAF filter cake, and/or within the near-wellbore invaded zone of the formation to mitigate formation permeability alterations due to the NAF fluid and related material.

Placing the operations fluid into the wellbore may also include introducing the fluid into the wellbore for purposes of moving the fluid into contact with the formation, such as a reservoir formation that may be associated with hydrocarbon production. For example, the operations fluid may be introduced into the formation as part of a formation matrix acid job, or as part of a formation hydraulic fracturing initiative that may use the operations fluid in conjunction with an inorganic acid and/or proppant materials.

Commonly, the step of placing the operations fluid into the wellbore comprises combining the water, the at least one inorganic acid, and the alkyl acid surfactant together as a “treatment pill” prior to placing the operations fluid into the wellbore. The term treatment pill generally refers to pumping a defined volume of the pre-prepared operations fluid into the wellbore in one step, for accomplishing a specific operational purpose. Preparing a treatment pill at the surface enables ensuring thorough and proper mixing and distribution of the combined materials with each other, resulting in improved quality control, as compared to downhole mixing of the operations fluid components. After preparing the operations fluid treatment pill, the pill may be spotted in the wellbore in contact with the NAF filter cake. Spotting may involve merely displacement and leaving the pill in contact with the NAF for a selected time duration, such as for at least 15 minutes, or up to one hour, or from between 5 minutes and one hour. The operations fluid also may be bullheaded into through the NAF, or displaced further into the near-wellbore altered zone invaded by the NAF drilling fluid. In other methods, the operations fluid may be applied using an energized stream and/or turbulent flow or circulation, to cause the operations fluid to physically wash, erode, or otherwise mechanically and chemically penetrate the NAF to remove the same from the wellbore face or formation.

In addition to use as a drilling fluid, the improved operations fluid may be incorporated into any of various methods for treating a geologic formation (including continuous sections, portions thereof, and multiple intervals) that are penetrated by a wellbore. An exemplary method may include the steps of preparing a treatment pill comprising: water; at least one inorganic acid; and an alkyl acid; placing the treatment pill into a wellbore; and disposing the treatment pill in contact with the formation penetrated by a wellbore. In addition to contacting an NAF filter cake along the wellbore face, the operations fluid may be incorporated into other methods such as disposing the treatment pill in contact with at least one of an open-hole section, a natural fracture zone, an operations-created fracture zone (such as created by stimulation treatment or by the drilling fluid during drilling operations), and/or along a cased or open hole section of the wellbore zone to be perforated, gravel packed, or cemented. In other methods or uses, the operations fluid is used wherein the NAF filter cake is formed on a wellbore wall in an un-cemented cased hole segment of the wellbore, and/or wherein the operations fluid is applied to the un-cemented cased hole segment of the wellbore. In other instances, the operations fluid may be used in conjunction with a drilling operation that involves drill pipe in contact an NAF filter cake, wherein the operations fluid is used to mitigate drill pipe sticking in the NAF filter cake by introducing the operations fluid into contact with the NAF filter cake. Other methods utilizing the operations fluid may include a formation stimulation operation that includes or is preceded by an NAF filter cake treatment operation. The stimulation treatment operation may include, for example, at least one of matrix acidizing, acid fracturing, and/or a hydraulic fracturing or acid fracture stimulation treatment that includes proppant.

### EXAMPLES

The effectiveness of the disclosed drilling fluid at preventing or controlling the formation of damaging NAF filter cakes while drilling may depend upon the ability of the disclosed drilling fluid to be entrained within the formed NAF filter cake as the filter cake is being formed or penetrating into the filter cake after formation of such filter cake, such that subsequently breaking, removing, or penetrating the NAF filter cake with acid stimulation fluid is readily permissible. Thereby, the formation may be effectively acidized. However, it may be highly desirable to utilize the disclosed drilling fluid while drilling the wellbore such that the fluid is entrained within the NAF filter cake as the NAF filter cake is being formed, as opposed to subsequently trying to introduce the fluid into an already formed NAF filter cake. The following non-limiting examples illustrate the effectiveness of the disclosed drilling fluid composition or system to form a readily degradable NAF filter cake so as to permit an effective acid stimulation.

Preparation of an Exemplary NAF Drilling Fluid Composition in a Laboratory Environment:

An exemplary NAF mud composition according to the present disclosure was made from using a commercially popular and common emulsifying NAF drilling fluid system (a commonly prepared Oil-Based Drilling Fluid solution (OBDF) with a final mud weight of about 12.4 ppg (1486 kg/m³, 1.486 g/cm³)). The prepared OBDF NAF solution was divided into two samples. To one (Exemplary) sample, 2 g of an alkyl acid surfactant R—X was added to 100 g of the prepared OBDF solution, wherein R=dodecyl benzene and X═—SO₃H. The other sample (Comparative sample) did not receive the surfactant. The samples were stirred well, resulting in the drilling fluid compositions to be used in the tests.

Preparation of an Exemplary Filter Cake from the Exemplary OBDF NAF:

The Exemplary NAF composition was used to produce an exemplary filter cake by filtering the prepared OBDF composition through a limestone disk. A dynamic high pressure high temperature unit was used for the filtration. The following conditions were used: Pressure differential was 800 psi (5.516 MPa), temperature was 200° F. (93° C.), with 750 rpm mixing during filtration.

Preparation of Filter Cake from Comparative OBDF NAF:

For comparison purposes, a sample of the OBDF solution that did not include the alkyl acid surfactant was used to produce a Comparative NAF filter cake using the same dynamic high pressure high temperature unit as used in the Exemplary tests. The following conditions were used: Pressure differential was 800 psi (5.516 MPa), temperature was 200° F. (93° C.), with 750 rpm mixing during filtration.

Filter Cake Properties:

Table-1 discloses various properties of both the Exemplary NAF filter cake and the Comparative NAF filter cake. The water contact angle and adhesion surface tension of the Exemplary NAF filter cake are significantly reduced as contrasted with such properties of the Comparative NAF filter cake. This indicates that the Exemplary NAF filter cake is more water wetting and relatively loosely held to the limestone compared to the Comparative NAF filter cake. Additionally, a significant change in the filter cake composition is also observed. Lower oil content and the presence of the R—X containing surfactant was observed in the non-damaging NAF filter cake.

TABLE 1

| | Observed | | wt % | | |
|---|---|---|---|---|---|
| FILTER | H₂O Contact | Adhesion, | Oil and | wt % | wt % |
| CAKES | Angle | N/m² | Water | Solids | Additives |
| Comparative | 98° | 5.3 | 33 | 63 | 4 |
| Exemplary | 23° | 0.44 | 9 | 89 | 2 |

Dispersion Tests on the Exemplary Filter Cake:

2.5 gram of the Exemplary surfactant-containing OBDF filter cake was removed from the Exemplary limestone disk and placed in a jar, to which 25 mL of 15% HCl acidizing solution was added. The jar was placed in an oven at 80° C. for 30 minutes. After 30 minutes the jar was taken out and shaken by hand for 1 minute. A complete break up and dispersion of all the filter cake was readily observed.

Dispersion Tests on Comparative Filter Cake:

2.5 gram of the Comparative filter cake was removed from the Comparative limestone disk and placed in a jar, to which 25 mL of 15% HCl acidizing solution was added. The jar was placed in an oven at 80° C. for 30 minutes. After 30 minutes the jar was taken out and shaken by hand for 1 minute. The filter cake did not readily break up and no dispersion of the filter cake was observed.

Injection Tests on the Exemplary Filter Cake:

1 mL of a 15% HCl acidizing solution was injected at a velocity of 0.71 m/s directly on the disk containing the Exemplary filter cake. After 5 minutes, the filter cake was scrapped off the treated disk and analyzed using a Keyence digital topography microscope. The depth of etch created by the acidizing solution was determined. An etch of depth 750 to 800 micron was achieved.

Injection Tests on Comparative Filter Cake:

1 mL of a 15% HCl acidizing solution was injected at a velocity of 0.71 m/s directly on the disk containing the Comparative filter cake. After 5 minutes, the filter cake was scrapped off the treated disk analyzed using a Keyence digital topography microscope. The depth of etch created by the acidizing solution was determined. No etching was achieved.

The OBDF NAF filter cake forms a “water-in-filter cake” material and the limestone disk is not etched by the acid. In contrast, the non-damaging NAF filter cake breaks and is dispersed. This enables the limestone disk to be etched. The altered properties of the non-damaging NAF filter cake enable the facile breaking and dispersion.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

In the present disclosure, several of the illustrative, non-exclusive examples of methods have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities, other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” may mean A alone, B alone, C alone, A and B together, A and C together, B and C together, A, B and C together, and optionally any of the above in combination with at least one other entity.

What is claimed:

1. An operations fluid composition for operations on wells associated with the production of hydrocarbons, the fluid composition comprising:
not less than 40 wt % of hydrocarbon fluid, based upon the total weight of the fluid composition;
water; and
from 0.1 to 20 wt % of an alkyl acid surfactant, based upon the total weight of water in the fluid composition.

2. The operations fluid composition of claim 1, further comprising:
from 40 to 70 wt % of hydrocarbon fluid;
from 5 to 20 wt % of water, based upon the total weight of the fluid composition; and
from 0.10 to 20 wt % of an alkyl acid surfactant.

3. The operations fluid of claim 1, wherein said alkyl acid surfactant has the general formula R—X, wherein R is selected from the groups comprising linear and branched alkyl and alkyl aryl hydrocarbon chains of from 6 to 24 carbons, and X comprises an acid.

4. The operations fluid of claim 3, wherein X comprises an acid selected from the group comprising sulfonic acids, carboxylic acids, phosphoric acids, and mixtures thereof.

5. The operations fluid of claim 1 wherein said alkyl acid comprises an acid selected from the group consisting of alkyl carboxylic acid, alkyl sulfonic acid, alkyl phosphoric acid, alkyl aromatic carboxylic acid, alkyl aromatic sulfonic acid, alkyl aromatic phosphoric acid, alkyl aryl carboxylic acid, alkyl aryl sulfonic acid, alkyl aryl phosphoric acid and mixtures thereof.

6. The operations fluid of claim 3, wherein the aryl group of the alkyl aryl hydrocarbon chain comprises at least one of a 1-ring and a 2-ring aromatic group.

7. The operations fluid of claim 6, wherein the aromatic group comprises at least one of benzene, toluene, and xylene.

8. The operations fluid of claim 3, wherein the aryl group comprises at least one of dodecyl benzene, decyl xylene, decyl benzene, dodecyl toluene, and mixtures thereof.

9. The operations fluid of claim 3, wherein X comprises a sulfonic acid group.

10. The operations fluid of claim 3, wherein said alkyl group of the alkyl acid surfactant comprises a carbon chain length in a range of from 6 to 24 carbon atoms.

11. The operations fluid composition of claim 1, further comprising:
from 2 to 50 wt % of solid particulate media, based upon the total weight of the fluid composition.

12. The operations fluid of claim 1, wherein said alkyl acid surfactant is present in the operations fluid at a concentration in the range of 0.1 to 20 wt % based on the total weight of water in the operations fluid.

13. The operations fluid of claim 1, wherein said alkyl acid is present in the operations fluid at a concentration in the range of 0.5 to 10 wt % based on the total weight of water in the operations fluid.

14. The operations fluid of claim 1, wherein said alkyl acid is present in the operations fluid at a concentration in the range of 2 to 10 wt % based on the total weight of water in the operations fluid.

15. The operations fluid of claim 1, further comprising an inorganic acid comprising at least one of hydrochloric, hydrofluoric, formic, nitric, sulfuric, and mixtures thereof.

16. The operations fluid of claim 1, wherein the operations fluid is adapted for use during at least one of drilling operations, completion operations, logging operations, casing operations, cementing operations, stimulation operations, production operations, and injection operations.

17. The operations fluid of claim 1, wherein the operations fluid is adapted to create a non-aqueous fluid (NAF) filter cake during an operation related to creating the wellbore for use in hydrocarbon recovery operations.

18. The operations fluid of claims 1, wherein the operations fluid is adapted to contact an existing NAF filter cake within the wellbore to alter the wettability of the existing NAF filter cake from oil wetting to water wetting.

19. A method for creating a wellbore for use in operations associated with the production of hydrocarbons, the method comprising:
preparing an operations fluid comprising
not less than 40 wt % of hydrocarbon fluid, based upon the total weight of the fluid composition;
water; and
from 0.10 to 20 wt % of a surfactant selected from alkyl acid surfactant, based upon the total weight of water in the fluid composition; and
introducing the prepared operations fluid into the wellbore in conjunction with a wellbore operation.

20. The method of claim 19, further comprising:
preparing an operations fluid comprising:
from 2 to 50 wt % of solid particulate media, based upon the total weight of the fluid composition;
from 40 to 70 wt % of hydrocarbon fluid;
from 0.5 to 20 wt % of water, based upon the total weight of the fluid composition; and
from 0.10 to 20 wt % of an alkyl acid surfactant; and
introducing the prepared operations fluid into the wellbore in association with an.

21. The method of claim 19 wherein preparing the operations fluid comprises preparing the alkyl acid surfactant that includes the general formula R—X, wherein R is selected from the groups comprising linear and branched alkyl and alkyl aryl hydrocarbon chains of from 6 to 24 carbons, and X comprises an acid.

22. The method of claim 19, further comprising introducing the operations fluid into the wellbore as a drilling fluid.

23. The method of claim 19, further comprising introducing the operations fluid into the wellbore subsequent to drilling the wellbore, and in contact with a NAF filter cake.

24. The method of claim 19, further comprising introducing the operations fluid into the wellbore in conjunction with a well completion operation.

25. The method of claim 19, further comprising introducing the operations fluid into the wellbore prior to an acid stimulation operation.

26. The method of claim 19, further comprising producing hydrocarbons from the wellbore or an off-set wellbore, subsequent to the wellbore operations.

27. The method of claim 19, wherein said alkyl acid surfactant is present in the operations fluid at a concentration in the range of 0.1 to 20 wt % based on the total weight of water in the operations fluid.

28. The method of claim 19, wherein said alkyl acid is present in the operations fluid at a concentration in the range of 0.5 to 10 wt % based on the total weight of water in the operations fluid.

29. The method of claim 19, wherein said alkyl acid is present in the operations fluid at a concentration in the range of 2 to 10 wt % based on the total weight of water in the operations fluid.

30. The method of claim 19, further comprising introducing the operations fluid into the wellbore during an operation related to at least one of drilling operations, completion operations, logging operations, casing operations, cementing operations, stimulation operations, hydrocarbon production operations, and fluid injection operations
